(19) United States
(12) Patent Application Publication
(10) Pub. No.: US 2007/0133543 A1
(43) Pub. Date: Jun. 14, 2007

(54) Communication Terminal Device

(75) Inventor: Shinji Kawasaki, Kyoto-shi, Kyoto (JP)

Correspondence Address: HOGAN & HARTSON L.L.P., 1999 AVENUE OF THE STARS, SUITE 1400, LOS ANGELES, CA, 90067, US

(73) Assignee: MURATA KIKAI KABUSHIKI KAISHA, Kyoto-shi (JP)

(21) Appl. No.: 11/566,564

(22) Filed: Dec. 4, 2006

(30) Foreign Application Priority Data
Dec. 13, 2005 (JP) 2005-358904

(51) Int. Cl. H04L 12/56

(52) U.S. Cl. 370/392; 370/401

(57) ABSTRACT

A communication terminal device that carries out broadcast communication with a plurality of other ends, includes an entry accepting unit, a searching unit, a fixing unit, and a destination information storage unit. The entry accepting unit accepts entry of destination information designated by a user. The searching unit searches a destination information storage device using the destination information as a search key. The fixing unit fixes the destination information that matches the search key in the searching unit as the other end. The destination information storage unit can store a plurality of the other ends which have been fixed. The searching unit does not search other ends that are already fixed by the fixing unit.

### RELATED APPLICATIONS

This application claims priority under 35 USC 119 in Japanese patent application no. 2005-358904, filed on Dec. 13, 2005, which application is hereby incorporated by reference in its entirety.

### BACKGROUND OF THE INVENTION

1. Field of the Invention

The present invention relates to a communication terminal device, and in particular, relates to a communication terminal device which can communicate after confirming a designated other end.

2. Description of the Related Art

A conventional method in a communication terminal device, such as a fax machine, for designating the other party includes a method for designating a fax number of the other party by a speed-dial or from a telephone directory or the like, and a method for directly entering a fax number using a ten-key numeric pad or the like. In case of the former, a registration operation to the telephone directory can be troublesome. In case of the latter, a wrong number may be entered by mistake. In order to solve such problems, a conventional device recognizes characters described in an entry column, such as a fax number or a name of the other end described in a transmittal cover page, and refers to a telephone directory database to confirm its presence. The conventional device determines whether or not information described in the cover page matches information stored in the telephone directory database. When the information described in the cover page matches the information stored in the telephone directory database, the conventional device automatically establishes a connection with the other end, and transmits image data of a fax document including the cover page to the other end.

Recently, a communication terminal device, such as a fax machine and a Multi Function Peripheral (MFP), can connect to a network such as a Local Area Network (LAN) and the Internet. A recently known communication terminal device refers to a database on the network to verify a fax number or the like entered by operating the ten-key numeric pad, and acquires a name of a destination that matches the fax number or the like. Then, the acquired name is displayed on an operation panel of the communication terminal device to confirm the name of the destination.

However, in case of broadcast communication in which a plurality of other ends are designated, it is desirable to efficiently verify the plurality of other ends within a short period of time. A complicated operation is required when editing the other end which has been fixed once. Thus, there is a need for improvement of such editing operations.

### SUMMARY OF THE INVENTION

In order to overcome the problems described above, the present invention provides a communication terminal device that efficiently verifies a plurality of other ends and that is user-friendly.

According to one aspect of the present invention, a communication terminal device, which can carry out a broadcast communication with a plurality of other ends, includes an accepting unit, a searching unit, a fixing unit, and a destination information storage unit. The accepting unit accepts destination information designated by a user. The searching unit searches a destination information storage device with the destination information accepted by the accepting unit as a search key. The fixing unit fixes the destination information that matches the search key in the searching unit as an other end. The destination information storage unit can store a plurality of pieces of destination information fixed by the fixing unit. The searching unit does not search the other end already fixed by the fixing unit.

For example, the communication terminal device may be an Internet fax machine, an MFP, a G3 or a G4 fax machine and a telephone set connected to a Public Switched Telephone Network (PSTN), an Internet Protocol (IP) telephone set, an e-mail terminal, a mobile terminal such as a mobile telephone set and a Personal Digital Assistant (PDA), or a computer such as a personal computer.

The destination information is information indicating the other end to which the communication terminal device carries out a communication. For example, the destination information may include a telephone number, a fax number, an Internet fax number, an IP telephone number, an e-mail address, an IP address, or a name. The destination information may be entered and designated by the user using an operation key, or designated using information described in an e-mail or a webpage.

The destination information storage device may be an electronic address book of the communication terminal device, a remote storage device, and a database provided by a directory service or the like connected via a network. At least one destination information storage device may be previously designated to be searched. The destination information storage device to be searched may be selected or changed as appropriate.

In one aspect, the other end of the communication may be fixed after verifying with the database, and the verification is not carried out with the database for the already fixed other end. Therefore, even when designating a plurality of other ends, a period of time required for the verification can be reduced. In addition, the communication terminal device can prevent an error when entering the other end. As a result, the user-friendliness of the communication terminal device improves.

The communication terminal device also includes an editing unit. Under an editing mode when an editing operation may be performed with respect to the destination information stored in the destination information storage unit, the editing unit accepts the editing operation for any one of the destination information by the user, and executes the editing operation. When the editing unit edits the already fixed destination information, the searching unit searches only the destination information which has been edited by the editing unit.

The communication terminal device also includes a fixing flag storage unit, and a control unit. The fixing flag storage unit prepares and stores a fixing flag for each of the destination information accepted by the accepting unit. The control unit resets a fixing flag of the destination information until the destination information accepted by the accepting unit is fixed. The control unit sets the fixing flag of the destination information after the fixing unit fixed the destination information as the other end. The searching unit does not search the destination information in which the fixing flag is set.

According to the invention, since the destination information of the other end can be edited after the destination information has been fixed, the communication terminal device is user-friendly. Since the verification with the database is not executed for the other end which has already been fixed and not edited, the time required for verification with the database is reduced, and verification with the database is carried out efficiently.

In one embodiment, when the editing unit edits the destination information, the control unit controls to reset the fixing flag of the destination information and to carry out the search by the searching unit.

In one embodiment, the accepting unit accepts the destination information in form of a character string, and stores as the other end the character string indicating the destination information in the destination information storage unit. Under the editing mode, the editing unit can delete all the character strings indicating one destination information among the other ends stored in the destination information storage unit.

In one embodiment, the accepting unit accepts the destination information in form of the character string, and stores the character string of the destination information in the destination information storage unit. Under the editing mode, the editing unit displays a cursor for designating an editing figure in the character string indicating the destination information stored in the destination information storage unit to enable the editing operation to be performed.

The communication terminal device also includes a notification unit. When there is no destination information that matches with the search key in the searching unit, the notification unit notifies such a fact. Accordingly, the notification unit can notify the user that there is no designated destination information and a possibility of an error to urge the user to designate the destination information again.

In one embodiment, in case of the absence of the destination information that matches the search key in the searching unit, the editing unit proceeds onto the editing mode of the destination information. Accordingly, in case of the absence of the designated destination information, the communication terminal device can automatically edit the destination information. Thus, the communication terminal device is user-friendly.

The communication terminal device also includes a presenting unit which presents destination information that matches the search key in the searching unit. The presenting unit can display a destination name or the like of the destination information that matched with the search key on a screen to urge the user to confirm the displayed destination name. Accordingly, the user can confirm the destination name or the like obtained by verifying the destination information designated by the user with the database. As a result, the user can confirm whether or not the destination information is correct.

In one embodiment, the destination information storage device may include a database of a directory server such as the Lightweight Directory Access Protocol (LDAP).

Further, any combinations of the above-described constituent elements and the conversions of the expression of the present invention between a method, a device, a system, a recording medium, a computer program or the like are also effective as a preferred embodiment of the present invention.

The present invention provides a communication terminal device which can efficiently verify a plurality of other ends and which is user-friendly.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram of a network configuration of a communication terminal device according to one embodiment of the present invention.

FIG. 2 is a schematic functional block diagram of the communication terminal device illustrated in FIG. 1.

FIG. 3 is a schematic functional block diagram illustrating an editing process function of the communication terminal device illustrated in FIG. 1.

FIG. 4 is a flowchart illustrating an example of an operation performed by the communication terminal device illustrated in FIG. 1.

FIG. 5 illustrates display examples of a display unit and a fixing flag when designating destination numbers for a broadcast communication in the communication terminal device illustrated in FIG. 1.

FIG. 6A and FIG. 6B illustrate display examples of the display unit and a fixing flag when editing an entered number in the communication terminal device illustrated in FIG. 1.

### DETAILED DESCRIPTION OF THE INVENTION

Embodiments of the present invention are described with reference to the attached drawings. Like reference numerals are assigned to like constituent elements in all drawings, and a description is omitted as appropriate.

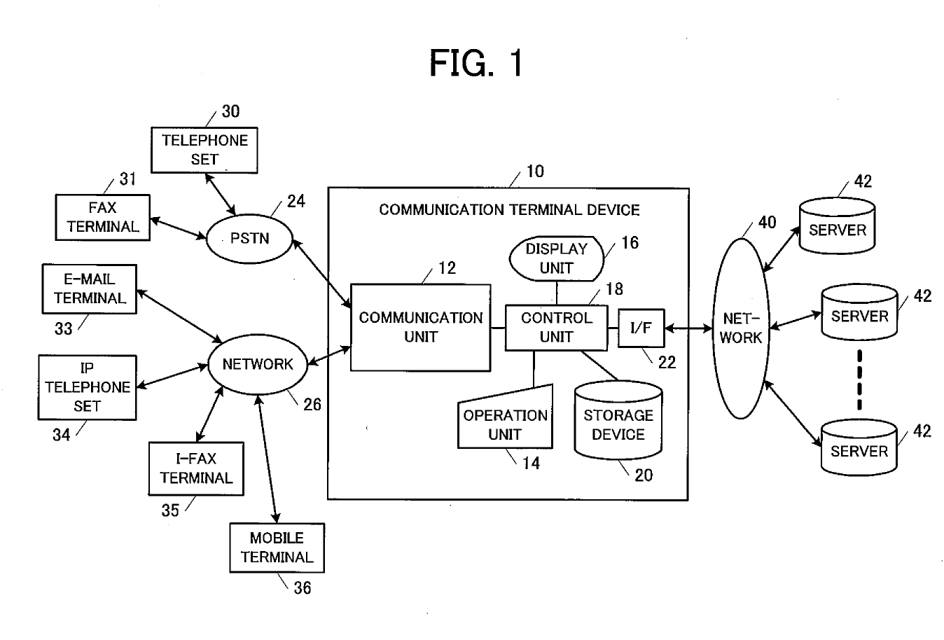

FIG. 1 is a block diagram of a network configuration of a communication terminal device according to one embodiment of the present invention. A communication terminal device 10 is connected to a plurality of directory servers (in the drawings, “server”) 42 via a network 40. Each directory server 42 includes a database (not illustrated) storing various pieces of information. The communication terminal device 10 transmits a search condition to the directory server 42 to execute the search by the directory server 42. Then, the communication terminal device 10 acquires a search result from the directory server 42. For example, the communication terminal device 10 uses a directory service based on the LDAP to execute a search based on the LDAP by the directory server 42.

The database of the directory server 42 stores address information including a plurality of attributes for a plurality of registrants, e.g., a name, a corporate name, a department, a telephone number, a fax number, an IP fax number, and an e-mail address. Communication terminal device 10 inquires the directory server 42 to acquire address information of another end.

The communication terminal device 10 communicates with another communication terminal device via a plurality of communication channels. For example, the communication terminal device 10 carries out voice communication and data communication with another telephone set 30 and another fax terminal 31 via a PSTN 24. The communication terminal device 10 carries out voice communication and data communication with another e-mail terminal 33, another IP telephone set 34, another Internet fax terminal 35, and another mobile terminal 36 via a network 26 such as the Internet and/or a LAN.

The telephone set 30 may be, for example, another mobile telephone terminal (not illustrated) connected via a wireless base station (not illustrated) and a wireless relay station (not illustrated). The fax terminal 31 may be, for example, another G3 or G4 fax terminal which communicates through the PSTN 24. The e-mail terminal 33, the IP telephone set 34, the Internet fax terminal 35, and the mobile terminal 36 are communication terminal devices, such as another computer, another IP telephone terminal, or another Internet fax terminal, that communicate via a network such as the Internet and/or the LAN.

In one embodiment, the communication terminal device 10 is, for example, a network fax machine, an MFP, or an Internet fax. In another embodiment, the communication terminal device 10 is a G3 or G4 fax machine or a telephone set connected to the PSTN, an IP telephone set, an e-mail terminal, a mobile terminal such as a mobile telephone set or a PDA, or a computer such as a personal computer. In FIG. 1, portions unrelated to the subject matter of the present invention are omitted. For example, a scanner unit, an image processing unit, a printer unit, a Modulator-Demodulator (MODEM), a Network Control Unit (NCU), a voice output unit, a sound collector, and a voice processing unit or the like, which may be components of a fax machine or a telephone set, are not illustrated.

When the communication terminal device 10 carries out a fax transmission to a destination which is not registered in an electronic address book or the like, a user operates a dial key of an operation panel of the communication terminal device 10 to enter a fax number. In order to confirm whether or not the manually-entered fax number is correct, the communication terminal device 10 verifies with the database of the directory server 42, and acquires a destination name from the directory server 42. Then, the communication terminal device 10 displays the acquired destination name. The user can carry out a fax transmission after confirming the displayed destination name. As a result, a wrong transmission resulting from an entry error of the fax number is prevented.

The communication terminal device 10 includes a communication unit 12, an operation unit 14, a display unit 16, a control unit 18, a storage device 20, and an interface unit 22.

Each element of the communication terminal device 10 is realized by a combination of hardware and software such as, for example, a Central Processing Unit (CPU) of a computer, a memory, a program which realizes the elements of FIG. 1 loaded to the memory, a storage unit such as a hard disk drive which stores the program, and an interface for establishing a connection with a network. It is understood by those skilled in the art that various changes and modifications can be made for methods and devices for realizing each of the elements of the communication terminal device 10. Thus, the drawings described hereinafter illustrate blocks representing units of function.

The communication unit 12 includes an interface function for communicating with the telephone set 30 and the fax terminal 31 or the like via the PSTN 24, and with the e-mail terminal 33, the IP telephone set 34, the Internet fax terminal 35, and the mobile terminal 36 or the like via the network 26.

The operation unit 14 receives an instruction of various settings and entries from a user. The operation unit 14 may be, for example, an operation button, a switch, a lever, a keyboard, or a touch-screen or the like. In one embodiment, the operation unit 14 includes a dial key (a ten-key numeric pad), a fax communication instruction key, a broadcast designation key, a transmission start instruction key, and an editing instruction key or the like arranged on an operation panel (not illustrated). The display unit 16 displays various pieces of information, an operation screen, and a performance or status of the communication terminal device 10. For example, the display unit 16 may be a lamp, a Light Emitting Diode (LED), a Cathode Ray Tube (CRT) monitor, or a Liquid Crystal Display (LCD).

The control unit 18 controls various elements of the communication terminal device 10 and also the entire communication terminal device 10. The storage device 20 includes a program area and a working area. The program area stores a control program for controlling the performance of the communication terminal device 10. The working area is used when the control unit 18 executes the program. The storage device 20 also includes a key entry buffer, a destination information storage unit, and a transmission data storage unit described hereinafter. The storage device 20 may also include a storage area for storing information such as an electronic address book.

The interface unit 22 communicates with a plurality of directory servers 42 connected via the network 40. In FIG. 1, the communication unit 12 and the interface unit 22 communicate via the network 40 and the network 26. However, the present invention is not limited to this example. The communication via the network 40 and the network 26 may be carried out by the same interface unit.

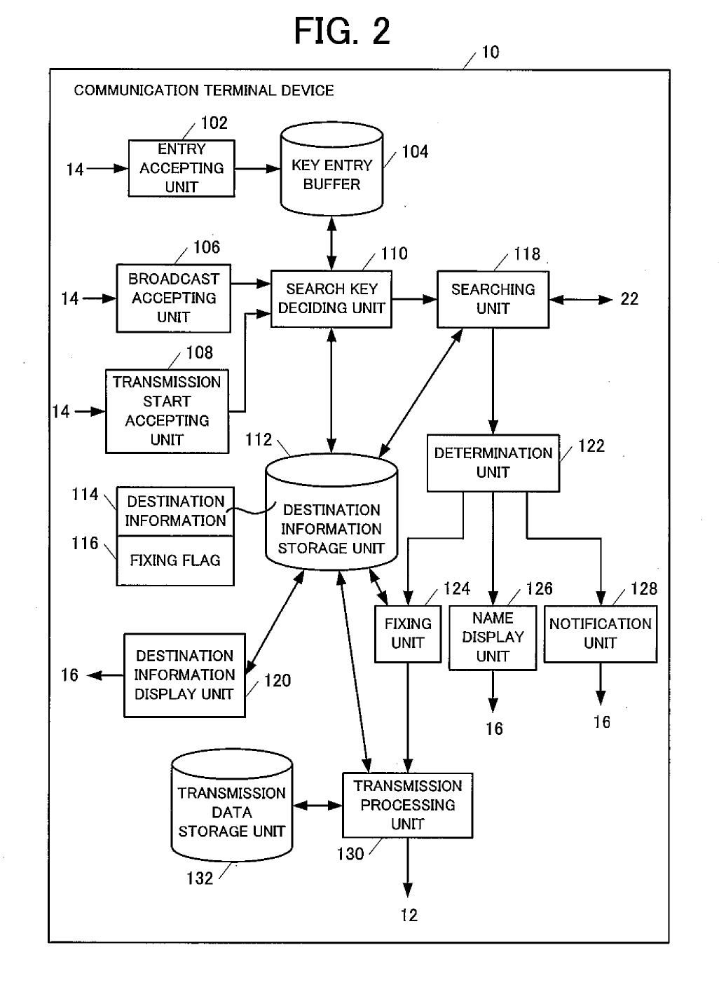

FIG. 2 is a schematic functional block diagram of the communication terminal device 10 according to one embodiment of the present invention. The communication terminal device 10 can carry out a broadcast communication with a plurality of other ends. The communication terminal device 10 includes entry accepting unit 102 for accepting destination information designated by the user, a searching unit 118 for searching a prescribed destination information storage device (i.e., the directory server 42 of FIG. 1) using the destination information accepted by entry accepting unit 102 as a search key, a fixing unit 124 for fixing the destination information that matches the search key in the searching unit 118 as the other end, and a destination information storage unit 112 which can store a plurality of other ends fixed by the fixing unit 124. The searching unit 118 does not search other ends already fixed by the fixing unit 124.

A program for controlling operation of the communication terminal device 10 operates a computer including the destination information storage unit 112, which can store a plurality of other ends designated when carrying out broadcast communication with the plurality of other ends, the entry accepting unit 102 for accepting destination information designated by the user, the searching unit 118 for searching a prescribed destination information storage device (the directory server 42 of FIG. 1) using the accepted destination information as a search key, the fixing unit 124 for fixing the destination information that matched with the search key as the other end, and the control unit 18 and a search key deciding unit 110 for controlling the searching unit 118 to not search other ends already fixed by the fixing unit 124.

Specifically, the communication terminal device 10 includes an entry accepting unit 102, a key entry buffer 104, a broadcast accepting unit 106, a transmission start accepting unit 108, a search key deciding unit 110, a destination information storage unit 112, destination information 114, a fixing flag 116, a searching unit 118, a destination information display unit 120, a determination unit 122, a fixing unit 124, a name display unit 126, a notification unit 128, a transmission processing unit 130, and a transmission data storage unit 132. The following description is with reference to FIGS. 1 and 2.

The entry accepting unit 102 accepts a character string including an alphanumeral, a character or the like entered by the user using operation unit 14 as destination information indicating the other end to which the communication terminal device carries out communication. For example, the destination information may include a telephone number, a fax number, an Internet fax number, an e-mail address, an IP address or a name. The entry accepting unit 102 may accept a character string of an e-mail address or the like described in an e-mail and a webpage. The key entry buffer 104 temporarily stores the character string accepted by the entry accepting unit 102.

The broadcast accepting unit 106 accepts operation of a broadcast designation key of the operation unit 14 performed by the user. The transmission start accepting unit 108 accepts operation of the transmission start instruction key of the operation unit 14 performed by the user. When the broadcast accepting unit 106 or the transmission start accepting unit 108 accepts an operation of a key, the search key deciding unit 110 decides a character string temporarily stored in the key entry buffer 104 as a search key, and delivers the search key to the searching unit 118. The search key deciding unit 110 stores the destination information expressed by the character string, which has been decided as the search key, in the destination information storage unit 112.

The destination information storage unit 112 includes the destination information 114 and the fixing flag 116. The destination information 114 stores destination information expressed by the character string, which has been decided by the search key deciding unit 110. The destination information storage unit 112 can store a plurality of pieces of destination information 114 as destinations for broadcast communication. A fixing flag 116 is provided for each destination information 114. The fixing flag 116 is set after corresponding destination information 114 has been fixed. Fixing the destination information 114 and the fixing flag 116 are described in detail later.

The searching unit 118 searches the database of the directory server 42 via the interface unit 22 using the character string decided by the search key deciding unit 110 as the search key. For example, the database of the directory server 42 stores address information such as a name, a fax number, an IP fax number, and an e-mail address, of a plurality of registrants. For example, the searching unit 118 searches the database of the directory server 42 using a fax number entered at the entry accepting unit 102 as the search key, and acquires address information such as a fax number and a name that matches the search key. The search result is delivered to the determination unit 122.

The searching unit 118 may also search an electronic address book stored in the communication terminal device 10. A storage device to be searched may be previously selected and designated from the plurality of the directory servers 42 and the electronic address book of the communication terminal device 10. The storage device to be searched may be selected or changed as appropriate.

The destination information display unit 120 displays on the display unit 16 the designated destination information and the address information such as the name searched by the searching unit 118. Accordingly, by referring to the displayed name, the user can confirm whether or not the designated destination information such as the fax number is the intended other end. That is, since a name of a different other end is displayed when the user has entered a wrong number, the user realizes that a wrong number has been entered.

The determination unit 122 determines which process to execute in accordance with the search result of the searching unit 118. According to the search result of the searching unit 118, when the corresponding fax number is stored in the database, the determination unit 122 displays the name of the fax number on the name display unit 126 and notifies the fixing unit 124. In case of an absence of a corresponding fax number, the determination unit 122 notifies such a fact to the notification unit 128. In addition, the determination unit 122 notifies the absence of the corresponding data to the user, and notifies such a fact to the notification unit 128.

In response to the notification from the determination unit 122, the fixing unit 124 accesses the destination information storage unit 112, and sets the fixing flag 116 of the destination information 114. The fixing unit 124 instructs the transmission processing unit 130 to start the transmission when the broadcast is not designated and when the transmission start accepting unit 108 has accepted an operation of the transmission start instruction key. When the broadcast accepting unit 106 has accepted an operation of the broadcast designation key, the fixing unit 124 does not instruct the transmission processing unit 130 to start the transmission.

The name display unit 126 displays a name on the display unit 16 in accordance with the instruction from the determination unit 122. In accordance with the instruction from the determination unit 122, the notification unit 128 displays a message on the display unit 16 indicating an absence of the corresponding data, or phonetically outputs a message or an alarm sound or the like from a speaker or the like (not illustrated). As described above, the notification unit 128 can notify the user of the absence of the designated destination information and a possibility of an entry error to urge the user to designate the destination information again.

The transmission processing unit 130 starts a transmission process in accordance with the instruction from the fixing unit 124. The transmission data storage unit 132 stores image data of an original document scanned by a scanner or the like (not illustrated). The transmission data storage unit 132 can also store an e-mail text created by an e-mail creating unit (not illustrated) and a designated attached file or the like. The transmission processing unit 130 instructs the communication unit 12 to transmit transmission data stored in the transmission data storage unit 132 to the destination information 114 stored in the destination information storage unit 112. When a broadcast communication is designated, the transmission processing unit 130 instructs the broadcast communication to a plurality of other ends.

In case of a fax transmission, when carrying out by a memory transmission, the communication unit 12 starts to store an entered fax number in a memory. When carrying out by a scanner transmission, the communication unit 12 starts dialing by the entered fax number. The communication unit 12 establishes a connection with another fax terminal 31 via the PSTN 24, and carries out a fax transmission of the image data of the original document.

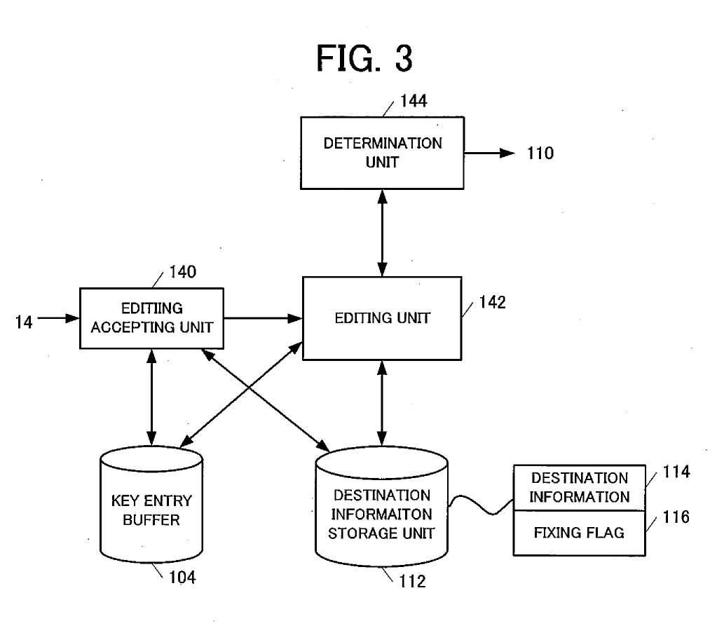

The communication terminal device 10 also includes an editing unit 142 for editing destination information as illustrated in FIG. 3. Under an editing mode in which an editing operation may be performed with respect to the destination information 114 of the other end stored in the destination information storage unit 112, the editing unit 142 accepts the editing operation for any one of the destination information 114 by the user and executes the editing operation. When the editing unit 142 edits destination information 114 that is already fixed, the searching unit (the searching unit 118 of FIG. 2) searches only the destination information 114 edited by the editing unit 142.

Specifically, the communication terminal device 10 also includes an editing accepting unit 140, the editing unit 142, and a determination unit 144. The editing accepting unit 140 accepts an operation of the editing instruction key of the operation unit 14 performed by the user, and a character string including an alphanumeral, a character or the like newly entered by the user. When the editing accepting unit 140 accepts an operation of the editing instruction key, the editing unit 142 proceeds to the editing mode in which the editing operation can be performed with respect to the destination information 114 stored in the destination information storage unit 112. In this case, the display unit 16 displays the destination information 114 stored in the destination information storage unit 112. In case of an absence of destination information that matches with the search key in the searching unit 118, the editing unit 142 automatically proceeds to the editing mode of the destination information in accordance with the instruction from the determination unit 122.

When the editing unit 142 proceeds onto the editing mode, the editing unit 142 entirely deletes the character string indicating one destination information 114 among the other ends stored in the destination information storage unit 112, and may urge the user to enter new destination information. In this case, the display unit 16 displays an entry cursor or the like. Alternatively, when the editing unit 142 proceeds onto the editing mode, the editing unit 142 can display a cursor for designating an editing digit in the character string of the destination information of the other end stored in the destination information storage unit 112. The user can edit a character or a number in the digit designated by moving the cursor by operating the operation unit 14. Alternatively, the user can selectively set either one of these two editing operation methods.

The determination unit 144 determines that the editing operation has been completed by the editing unit 142, and notifies such a fact to the search key deciding unit 110. In response to the notification, the search key deciding unit 110 instructs the searching unit 118 to carry out a search by a new search key.

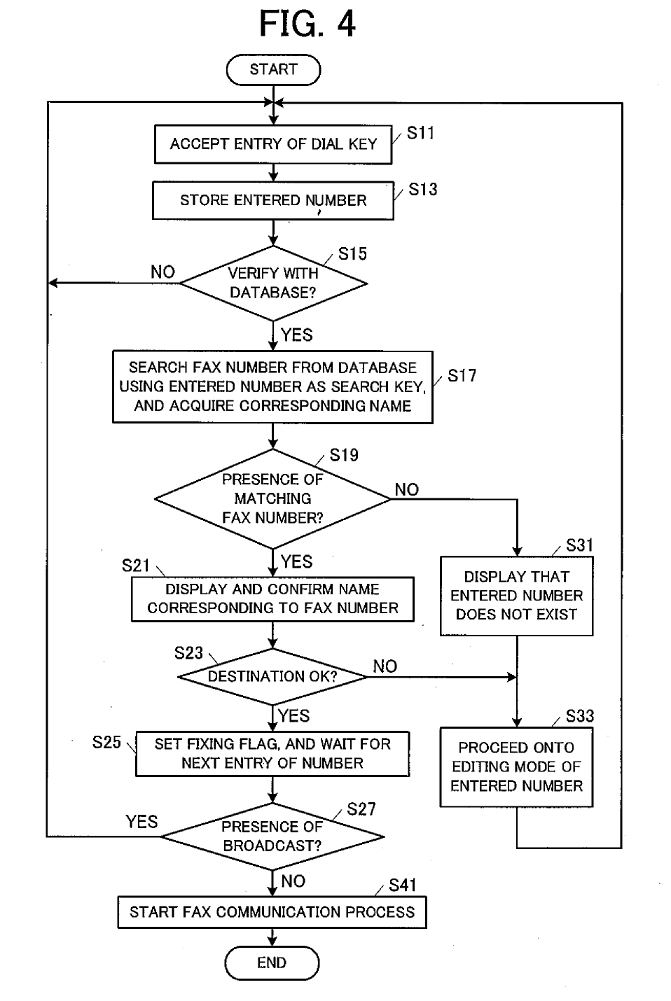

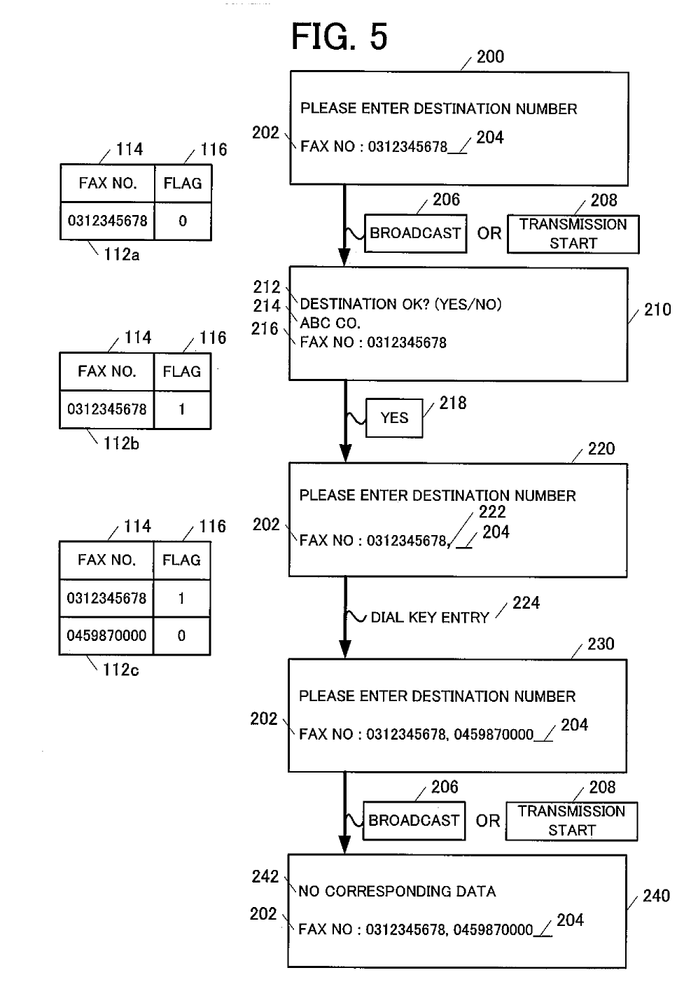

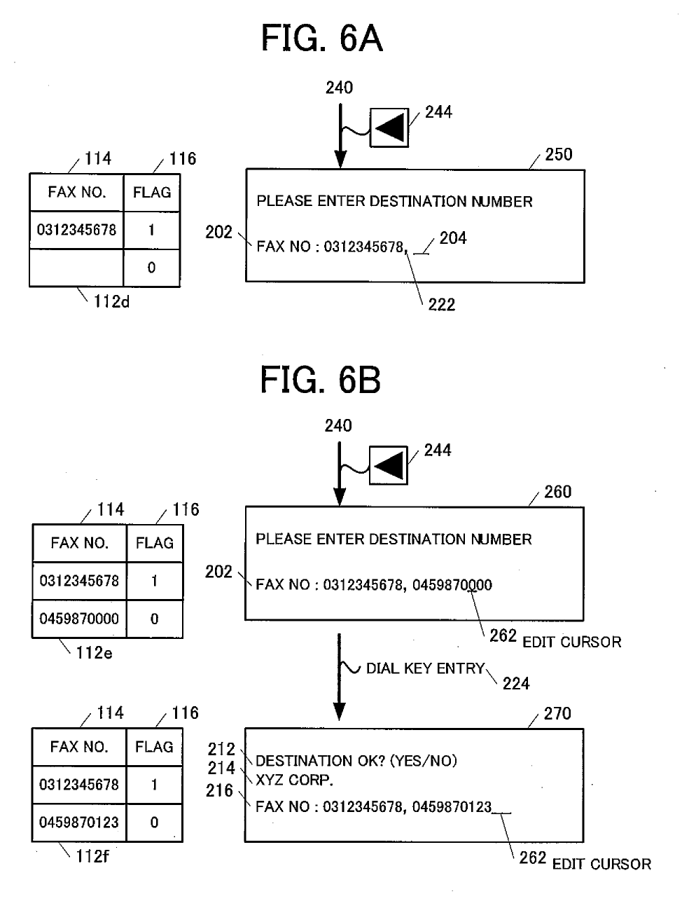

FIG. 4 is a flowchart illustrating an example of an operation carried out by the communication terminal device 10. An example in which a fax transmission is instructed to the communication terminal device 10 is described. However, the present invention is not limited to such an example. The same operation is performed at an e-mail transmission or other communication processes. FIG. 5 illustrates display examples of the display unit 16 and the fixing flag 116 when designating a broadcast communication to the destination numbers. FIG. 6 illustrates display examples of the display unit 16 and the fixing flag 116 when editing an entered number. The following description is with reference to FIGS. 1-6.

First, the entry accepting unit 102 accepts an entry of a dial key (step S11). As illustrated in FIG. 5, a fax number “0312345678” is entered. In this case, the display unit 16 displays a screen 200. The entered fax number is stored in the key entry buffer 104 (step S13). In this case, the screen 200 displays an entered destination number 202 and an entry cursor 204.

When the broadcast accepting unit 106 or the transmission start accepting unit 108 accepts an operation of the broadcast key 206 or the transmission start instruction key 208 so as to carry out a verification with the database (step S15: YES), the search key deciding unit 110 decides the fax number stored in the key entry buffer 104 as the search key. In this case, the fax number “0312345678” is stored in the destination information 114 of the destination information storage unit 112 (in FIG. 5, indicated as a destination information storage section 112a). “0” is set in the fixing flag 116.

The searching unit 118 accesses the database of the directory server 42 via the interface unit 22 and carries out the verification using the decided search key (step S17). In case of a presence of a matching fax number, a corresponding name is acquired from the directory server 42. Then, the determination unit 122 determines a presence or an absence of a matching fax number in accordance with the search result (step S19). In case of a presence of a fax number (step S19: YES), the name display unit 126 displays the name of the matching fax number on the display unit 16 and notifies to the fixing unit 124 (step S21). The fixing unit 124 displays a screen 210 illustrated in FIG. 5 on the display unit 16. The screen 210 displays a name 214, an entered fax number 216, and a message 212 confirming whether or not the destination is acceptable. As described above, since the user can confirm the destination corresponding to the entered fax number 216, it is possible to prevent an error transmission resulting from an entry error.

When the destination is acceptable (step S23: YES), i.e., when an accepting unit (not illustrated) accepts an entry of a YES key 218, “1” is set in the fixing flag 116 of the destination information storage unit 112 (in FIG. 5, illustrated as a destination information storage section 112b). Then, the entry accepting unit 102 waits for a next entry of a destination number, and the display unit 16 displays a screen 220 illustrated in FIG. 5 (step S25). The screen 220 displays a comma 222 indicating that the fax number of the destination information 202 has been fixed, and an entry cursor 204.

When entering a broadcast number (step S27: YES), the process returns to step S11, and the entry accepting unit 102 accepts a next destination number. A screen 230 illustrated in FIG. 5 displays a fax number of a next destination. When accepting an operation of the broadcast key 206 or the transmission start instruction key 208 so as to carry out the verification with the database (step S15: YES), a fax number “0459870000” is stored as the second destination number in the destination information 114 of the destination information storage unit 112 (in FIG. 5, illustrated as a destination information storage section 112c). Then, “0” is set in the fixing flag 116. When a broadcast number is not entered, a fax communication process starts (step S41).

The search key deciding unit 110 refers to the fixing flag 116 of the destination information storage unit 112, and decides only the second fax number “0459870000” as the search key, excluding the first fax number having “1” set in the fixing flag 116. Then, the searching unit 118 verifies with the database of the directory server 42 using only the second fax number “0459870000” as the search key (step S17). As described above, the searching unit 118 does not carry out the verification for the destination information which has been already verified. Thus, the time required for verification is reduced, and verification is carried out efficiently.

As a result, in case of an absence of a matching fax number (step S19: NO), the notification unit 128 displays a message 242 on a screen 240 illustrated in FIG. 5 (step S31). Further, the message 242 indicates that an entered number does not exist in the database.

When the entry cursor 204 in the screen 240 is moved by a left arrow key or the like, i.e., as illustrated in FIG. 6A, when the editing accepting unit 140 accepts an operation of a key 244, the process proceeds onto the editing mode (step S33). As illustrated in FIG. 6A, the second destination information 114 is deleted from the destination information storage unit 112 (in FIG. 5, illustrated as a destination information storage section 112d). Then, the process returns to step S11, and an entry of a new number is waited.

Alternatively, as illustrated in FIG. 6B, when the process proceeds onto the editing mode (step S33), the editing unit 142 displays an edit cursor 262 in an editing digit in a screen 260. Then, the determination unit 144 determines whether or not the edit cursor 262 has moved out from a second entered number, so as to carry out the verification with the database (step S15). Such a fact is notified to the search key deciding unit 110, and the newly entered number is decided as the search key (step S17). In this case, the searching unit 118 refers to the fixing flag 116 of the destination information storage unit 112 (in FIG. 6B, illustrated as a destination information storage section 112e), and a search is not carried out with respect to the destination information 114 in which “1” is set. That is, a search is carried out only for a fax number “0459870123” in which “0” is set in the fixing flag 116. The searching unit 118 carries out the verification with the database, and a verification result is displayed on a screen 270 as illustrated in FIG. 6B (step S21). As described above, since the verification with the database is carried out with respect to only the edited destination information, the time required for verification is reduced, and verification is carried out efficiently.

When accepting an instruction from the screen 270 that the destination is acceptable (step S23: YES), “1” is set in the fixing flag 116 corresponding to the fax number “0459870123” of the destination information 114 stored in the destination information storage unit 112 (in FIG. 6B, illustrated as a destination information storage section 112f), and an entry of a next number is waited (step S25).

Further, when the destination is determined not acceptable at step S23 (step S23: NO), the process automatically proceeds onto an editing mode of the entered number (step S33).

As described above, according to the communication terminal device 10 of the present invention, the other end of the communication can be fixed after verifying with the database, and the verification with the database is not carried out for the other end which has been already fixed. Therefore, the time required for verification is reduced, and entry of a wrong other end is prevented. Thus, usability of the communication terminal device 10 improves.

According to the communication terminal device 10 of the invention, since the destination information can be edited after the other end has been fixed, the communication device 10 is convenient. Furthermore, since the verification with the database is not carried out for the other end which has been already fixed and which has not been edited, the time required for verification with the database is reduced.

According to the communication terminal device 10 of the present invention, a notification is carried out regarding a fact that the designated destination information does not exist or a possibility of an error, and the communication terminal device 10 can urge the user to designate the destination information again. In case of the absence of the designated destination information, editing of the destination information automatically becomes capable of being carried out. Thus, the communication terminal device 10 is user-friendly.

Embodiments of the present invention have been described with reference to the drawings. The described embodiments are only examples, however, and the present invention may be modified or changed in numerous ways.

For example, the entry accepting unit 102 as described accepts an entry of a fax number. However, the present invention is not limited to this example. For example, the entry accepting unit 102 may accept an entry of an e-mail address, an IP fax number, a telephone number, and a name or the like. The searching unit 118 may search the name from the e-mail address, the IP fax number, or the telephone number, or search a fax number, an e-mail address, an IP fax number, or a telephone number from the name.

While the present invention has been described with respect to embodiments thereof, it will be apparent to those skilled in the art that the invention may be modified in numerous ways and may assume many embodiments other than those specifically set out and described above. The appended claims cover all modifications of the present invention that fall within the true spirit and scope of the present invention.

What is claimed is:

1. A communication terminal device, which carries out broadcast communication to a plurality of other ends, comprising:
an accepting unit that accepts designation of a plurality of pieces of destination information;
a searching unit that searches a destination information storage device using a destination information accepted by the accepting unit as a search key;
a fixing unit that fixes the destination information that matches the search key as an other end; and
a destination information storage unit that stores a plurality of the destination information fixed by the fixing unit,
wherein the searching unit does not search the destination information already fixed by the fixing unit.

2. The communication terminal device according to claim 1, further comprising an editing unit that performs an editing operation with respect to the destination information of the other end stored in the destination information storage unit,
wherein when the editing unit edits the destination information which has been already fixed, the searching unit searches only the destination information edited by the editing unit.

3. The communication terminal device according to claim 1, further comprising:
a fixing flag storage unit that prepares and stores a fixing flag for each of the destination information accepted by the accepting unit; and
a control unit that resets the fixing flag of the destination information until the destination information accepted by the accepting unit is fixed, and sets the fixing flag of the destination information after the fixing unit fixes the destination information as the other end,
wherein the searching unit does not search the destination information in which the fixing flag of the destination information is set.

4. The communication terminal device according to claim 2, further comprising:
a fixing flag storage unit that prepares and stores a fixing flag for each of the destination information accepted by the accepting unit; and
a control unit that resets the fixing flag of the destination information until the destination information accepted by the accepting unit is fixed, and sets the fixing flag of the destination information after the fixing unit fixes the destination information as the other end,
wherein the searching unit does not search the destination information in which the fixing flag of the destination information is set.

5. The communication terminal device according to claim 3, wherein when the editing unit edits the destination information, the control unit controls to reset the fixing flag of the destination information and to carry out a search by the searching unit.

6. The communication terminal device according to claim 4, wherein when the editing unit edits the destination information, the control unit controls to reset the fixing flag of the destination information and to carry out a search by the searching unit.

7. The communication terminal device according to claim 2, wherein the accepting unit accepts the destination information as a character string that is stored in the destination information storage unit as the other end, and
the editing unit entirely deletes the character string indicating one destination information of the other ends stored in the destination information storage unit.

8. The communication terminal device according to claim 2, wherein the accepting unit accepts the destination information as a character string that is stored in the destination information storage unit, and
the editing unit displays a cursor that designates an editing digit in the character string stored in the destination information storage unit to enable an editing.

9. The communication terminal device according to claim 1, further comprising a notification unit that notifies an absence of destination information that matches the search key in the searching unit.

10. The communication terminal device according to claim 2, further comprising a notification unit that notifies an absence of destination information that matches the search key in the searching unit.

11. The communication terminal device according to claim 2, wherein in case of the absence of the destination information that matches the search key in the searching unit, the editing unit proceeds onto the editing mode of the destination information.

12. The communication terminal device according to claim 1, further comprising a presenting unit that presents destination information that matched with the search key in the searching unit.

13. The communication terminal device according to claim 1, wherein the destination information storage device is a database of a directory server.

14. A method for carrying out broadcast communication in a communication terminal device comprising:
(a) accepting input of destination information;
(b) searching for a pre-stored destination that matches the input destination information;
(c) fixing the destination information when it matches a pre-stored destination; and
(d) accepting input of additional destination information, and performing steps (b) and (c) only for destination information that is not already fixed.

15. A method as claimed in claim 14, and further comprising:
(e) accepting edits in an editing mode to fixed destination information, and performing steps (b) and (c) only for destination information that is edited.

16. A method as claimed in claim 15, wherein the destination information is input as a character string.

17. A method as claimed in claim 16, wherein edits are accepted by first deleting the entire character string representing the destination information to be edited.

18. A method as claimed in claim 16, wherein edits are accepted by displaying a cursor within the character string representing the destination information to be edited.

19. A method as claimed in claim 15, and further comprising:
(f) providing a notification when there is no pre-stored destination that matches the input destination information.

20. A method as claimed in claim 19, wherein when there is no pre-stored information that matches the input destination information, the method automatically proceeds to the editing mode of step (e).
